(19) United States
(12) Patent Application Publication
(10) Pub. No.: US 2014/0299326 A1
(43) Pub. Date: Oct. 9, 2014

(54) Method to Generate Diversion and Distribution For Unconventional Fracturing in Shale

(71) Applicant: Baker Hughes Incorporated, Houston, TX (US)

(72) Inventor: James B. Crews, Willis, TX (US)

(73) Assignee: Baker Hughes Incorporated, Houston, TX (US)

(21) Appl. No.: 14/225,526

(22) Filed: Mar. 26, 2014

Related U.S. Application Data
(60) Provisional application No. 61/808,998, filed on Apr. 5, 2013.

(51) Int. Cl. E21B 43/267; C09K 8/62; E21B 43/26

(52) U.S. Cl. CPC E21B 43/267; E21B 43/26; C09K 8/62
USPC 166/308.1; 166/113; 507/200; 507/265; 507/269

(57) ABSTRACT

Relatively high viscosity materials and methods for introducing them as discrete bodies or masses into relatively low viscosity fluids, such as brine, give fracturing fluids that help control the diversion and distribution of fluids as they are pumped downhole against a subterranean formation, particularly shale, to fracture it. A wide range of relatively viscous materials may be used, including polymers, crosslinked polymers and/or surfactant gels, for instance gels created with viscoelastic surfactants (VESs). Once the fracturing fluids containing these bodies or masses are within the hydraulic fracture, the processes of paths of least resistance, flow deviation, viscous material flow displacement, total fluid diversion, in situ fluid viscosity generation and distribution of delayed release treatment additives may be deployed.

### CROSS-REFERENCE TO RELATED APPLICATION

This application claims the benefit of U.S. Provisional Patent Application Ser. No. 61/808,998 filed Apr. 5, 2013, incorporated herein by reference in its entirety.

### TECHNICAL FIELD

The present invention relates in one non-limiting embodiment to methods, compositions and apparatus to fracture subterranean formations, and more particularly relates, in another non-restrictive version, to methods, compositions and apparatus to generate diversion and distribution during the fracturing of subterranean shale formations.

### TECHNICAL BACKGROUND

Hydraulic fracturing of subterranean formations to extract hydrocarbons such as oil and gas is well known. Hydraulic fracturing (or “fracking”) involves a stimulation treatment performed on oil and gas wells in low-permeability reservoirs. Specially engineered fracturing fluids are pumped at high pressures and rates into the reservoir interval to be treated, causing a vertical fracture to open. The two wings of the fracture extend away from the wellbore in opposing directions according to the natural stresses within the formation. Proppant, which in one non-limiting embodiment may be grains of sand of a particular size, is mixed with the treatment fluid to keep the fracture open when the treatment is complete. Hydraulic fracturing creates high-conductivity communication with a large area of formation and bypasses damage that may exist in the near-wellbore area.

The recent surge in oil and gas production in North America has resulted from a combination of directional drilling and hydraulic fracturing of shale formations. Oil and gas in shale is tightly held and difficult to release. Indeed, it has been realized that conventional hydraulic fracturing needs to be reinvented to work optimally in shale formations.

The traditional fluid technology developed for conventional hydraulic fracturing has had limited success for fracturing shale formations. The fluid developmental trend over the past 40 years for newer and better crosslinked polymer systems has been abruptly halted and in many geographic areas replaced by simple and common slickwater. Slickwater or slick water fracturing is a method or system of hydro-fracturing which involves adding chemicals to water to increase the fluid flow. Such fluid can be pumped down the well-bore fast, such as at a rate of 100 bbl/min to fracture the shale. Without using slickwater the top speed of pumping is often slower, such as 60 bbl/min. The process involves injecting water containing friction reducers, usually a polyacrylamide or other polymer. Over the past decade, all types of hybrid fluids have been evaluated for shale treatments including the mix and match of slickwater with relatively low to relatively high viscosity polymeric systems.

There remains a need to find improved compositions, methods and apparatus to utilize fluid hydraulics and fluid viscosity for the shale fracturing industry.

### SUMMARY

There is provided in one non-limiting embodiment an apparatus for introducing a relatively higher viscosity material into a relatively lower viscosity fluid stream, where the apparatus includes at least one reservoir adapted to contain relatively higher viscosity material, at least one extrusion conduit in fluid communication between the at least one reservoir and at least one flow conduit containing the relatively lower viscosity fluid stream, at least one drive mechanism configured to drive the relatively higher viscosity material through the at least one extrusion conduit into the relatively lower viscosity fluid stream, at least one sizing mechanism adapted to divide the relatively higher viscosity material into discrete bodies of a predetermined size.

There is additionally provided in one non-restrictive version, a method for introducing a relatively higher viscosity material into a relatively lower viscosity fluid stream, where the method includes flowing a relatively lower viscosity fluid stream, driving a relatively higher viscosity material from a reservoir through at least one extrusion conduit and at least one sizing mechanism to divide the relatively higher viscosity material into discrete bodies of a predetermined size and shape, and metering the discrete bodies into the relatively lower viscosity fluid stream.

There is further provided in a non-limiting embodiment a method of generating diversion during the fracturing of a subterranean formation through which a wellbore has been drilled, where the method includes introducing through the wellbore, at a sufficient rate and pressure to fracture the subterranean formation, a brine fracturing fluid. The brine fracturing fluid includes a relatively lower viscosity fluid stream and a plurality of discrete bodies of a relatively higher viscosity material. The method additionally comprises diverting the relatively lower viscosity fluid stream by action of the discrete bodies of a relatively higher viscosity material.

Additionally there is provided a relatively high viscosity ratio fluid composition comprising a relatively lower viscosity fluid and a plurality of relatively higher viscosity material discrete bodies, where the viscosity ratio Vᵣ of the viscosity of the relatively higher viscosity material to the viscosity of the relatively lower viscosity fluid stream is 1000 or greater.

### BRIEF DESCRIPTION OF THE DRAWINGS

FIG. 1 is a schematic illustration of the surface equipment used in a treating method described herein, including a high Vᵣ introduction device;

FIG. 2 is a detailed schematic illustration of one embodiment of a high Vᵣ introduction device;

FIGS. 3a, 3b, 3c and 3d are schematic illustrations of how the discrete bodies of relatively higher viscosity material may vary;

FIGS. 4a, 4b and 4c are schematic illustrations of discrete bodies of relatively higher viscosity material having different materials contained therein;

FIGS. 5a and 5b are schematic illustrations of how discrete bodies of relatively higher viscosity material may be sized and formulated to generate viscosity under wall shear conditions in narrow fractures;

FIG. 6 is a schematic illustration of possible choke points in a complex fracture network;

FIG. 7 is a schematic illustration of an alternative embodiment of surface equipment employing perforated plates that may be used in a treating method described herein, including a high Vᵣ introduction device;

FIG. 8 a detailed schematic illustration of how sequentially placed perforated plates may size and/or shape discrete bodies within a relatively lower viscosity fluid stream.

It will be appreciated that the various Figures are not necessarily to scale and that certain features have been exaggerated for clarity and do not necessarily limit the features of the invention.

### DETAILED DESCRIPTION

Compositions, methods and apparatus have been discovered that control diversion and distribution of fluids, proppants and treatment additives in shale fracturing operations (fracs). Selectively produced is a High Viscosity Ratio Fluid (HVR Fluid) adapted for fracturing ultra-low permeability formations (i.e. coal seams, shales, and tight sands). Through use of an extrusion device a High Viscosity Material (HV Material) is added to relatively lower viscosity fluid stream (e.g. brine water) during a frac treatment to create the HVR Fluid. The relatively lower viscosity fluid stream may be brine and/or slickwater. It is often referred to as brine herein, but it should be understood that the fluid is not necessarily limited to brine. The HV Material size is typically very small so as to enter and flow in narrow width fractures, such as less than 1.0 mm in size. In one non-limiting embodiment, the HV Material is at least 1000 time more viscous than brine, and typically is more than 100,000 time more viscous than brine at 0.01 sec⁻¹ shear rate at 80° F. (27° C.).

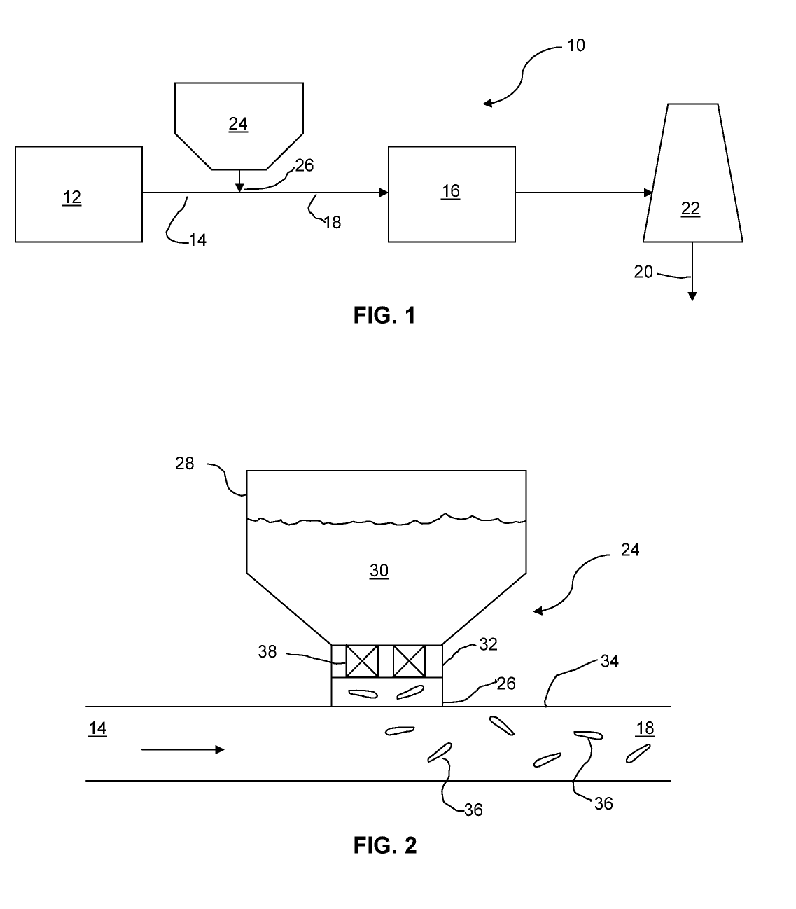

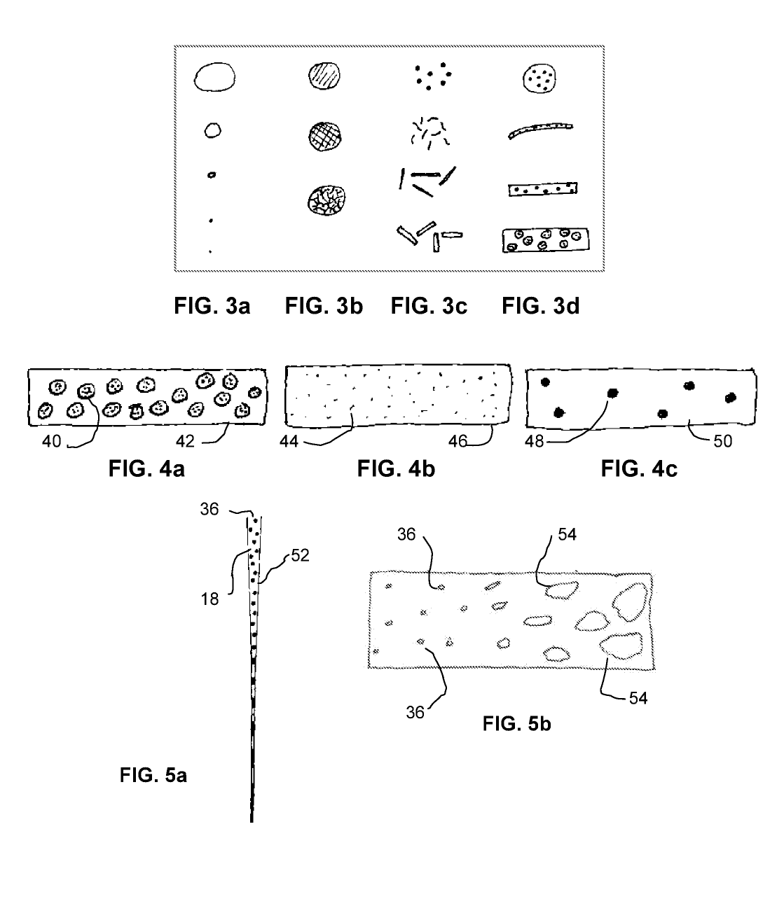

A wide range of viscous materials or gel technologies may be used to formulate the HV Material, including polymer and surfactant gels commonly used in the oilfield; for example in a non-limiting embodiment a 50 pptg borate crosslinked guar fluid system. The HV Material delivery device or apparatus is a mixer and/or additive tank with precision control for extruding viscous materials during a fracturing treatment, as shown in FIGS. 1 and 2. The device extrudes HV Materials of various shapes, sizes, compositions, and viscosity into brine during the treatment (see FIGS. 3 and 4). This process can create a spectrum of HVR Fluid. The HV Material effectively retains its size and shape in brine during wellbore pumping by the physical property that relatively much thinner, brine water has very poor shear energy transfer to small inclusions that have relatively very high viscosity at low shear rate. During the extrusion process the HV Material is introduced to brine as discrete tiny masses with near-zero shear rate viscosity. Most formulations of HV Material will be highly elastic and deformable and will resist fluid-shear-induced fragmentation.

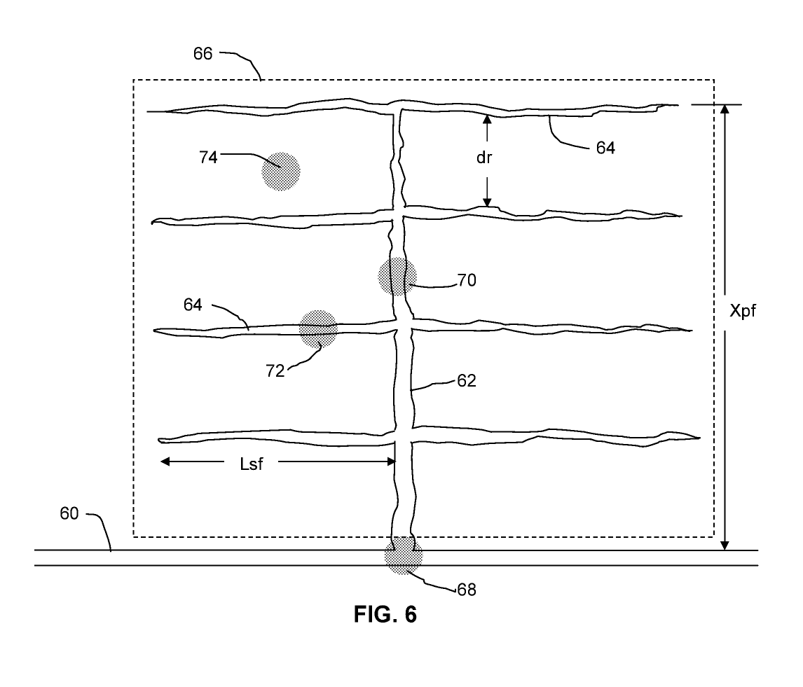

During a fracturing treatment, at the surface and within the wellbore the HVR Fluid will have brine-like fluid properties. The HVR Fluid may optionally have a friction reducer added to help reduced friction pressure (i.e. brine with conventional polyacrylamide friction reducers in an amount from about 0.25 to about 1 gptg; less than 5 pptg active polymer content). Depending on the size of the discrete HV Material bodies, in the planar (i.e. primary) fracture the HVR Fluid may still behave like brine water. Once the brine with discrete relatively highly viscous bodies and/or masses are within the hydraulic fractures with widths similar to or smaller than the HV Material bodies, the HVR Fluid will initiate change in its flow properties. By controlling the viscosity and shear sensitivity of the HV Material bodies, frictional interaction of the bodies with the walls of narrow fractures will cause the HVR Fluid to transition from a brine-like fluid to a combination of brine and viscous bodies having drag reduction and other fracture area and wall interaction properties. Once the HVR Fluid interacts with narrow hydraulic fractures the processes such as or similar to path of least resistance flow deviation, viscous material lodging in the fracture that produces reduced treatment fluid flow, total fluid diversion, in situ wall-shear induced fluid viscosity generation (discussed in more detail with respect to FIG. 5), and distribution of delayed released treatment additives can be engineered. Most of these processes will induce increased hydraulic fluid pressure (i.e. increased pressure drop within that specific region of the fracture). Increased fluid pressure may: a) reduce fluid flow in the fracture; b) increase fracture width, c) alter fracture extension, and eventually d) initiate creation of, and then flow in newly created fractures (i.e. induce fracture network complexity). During the treatment this fracture generating and fluid diversion process may be numerously repeated as an inherent characteristic of use of HVR Fluid. Combined or incorporated with optional lightweight proppants, selectively sized and shaped discrete HV Material bodies will better distribute the proppants in complex fracture networks. This use of discrete bodies with proppant placement and distribution in the fracture network will increase transitional fracture conductivity. That is, the proportion of nano-, micro-, and macro-darcy network conductivity from fracture tips to wellbore perforations may be more precisely controlled or engineered. The fracture network conductivity limited “choke points” (further discussed in more detail with respect to FIG. 6) may also be reduced by the viscous masses or bodies containing proppant which are retained at restrictive flow locations in the complex fracture network during the treatment. This technology is an alternative to conventional solid material diverters, for instance slowly soluble fairly hard and/or solid polymer particles (e.g. polylactic acid), and should provide more versatile treatment design, control and results.

By “planar fracture” is meant the primary fracture that generally extends on either side of a wellbore in a bi-wing structure. Planar fractures generally follow a vertical plane in the formation. By “complex fracture” is meant the secondary fractures that generally occur at approximately right angles to the primary, planar fractures. It is known in the art that fracturing ultra-low permeability reservoirs with slickwater the majority of fracture complexity (i.e. secondary, tertiary, etc.) occurs near the wellbore, particularly at lower treatment injection rates. A general trend with slickwater fracs is difficulty creating fracture complexity away from the wellbore; in other words, problems creating far-field complexity (i.e. away from the wellbore). Greater production of hydrocarbons may be achieved if fracture complexity (i.e. secondary, tertiary, etc.) occurs both near the wellbore and far-field.

Compositions, materials and devices are disclosed showing how to increase the generation and distribution of complex fractures in a formation, and increase transitional fracture conductivity, for instance by starting at the fracture tips create nanodarcy permeability to microdarcy permeability to millidarcy permeability to macrodarcy permeability in the numerous fractures leading to the wellbore.

A wide range of viscous materials may be used, including specially formulated polymer and surfactant gels commonly used in the oilfield, such as borate crosslinked guar and/or viscoelastic surfactant systems. Gelled hydrocarbons (e.g. gelled oils), viscous emulsions, viscous gelatins, viscoelastic polymeric fluids, vesicles, and other viscous fluid systems may also be used. The HV Material may be an aqueous or hydrocarbon based fluid or gel with a high resistance to flow (i.e. is highly viscous). The HV Material may also be materials of any kind with low water or low hydrocarbon content which permits them to become highly viscous during flow. Low water content in select HV Materials may be defined as: a) less than about 40% water; b) less than about 30%; and in some fluids less than about 20% water content by weight percent. Low liquid hydrocarbon content in select HV Materials may be defined as: a) less than about 60% liquid hydrocarbons; b) less than about 40%; and in some fluids less than about 30% liquid hydrocarbon content by weight percent. Suitable hydrocarbons may include, but are not limited to, alcohols, mineral oils, glycerin, glycols (including, but not necessarily limited to, mono-, di- and triethylene glycol), glycol ethers, d-limonene, terpenes, propylene and ethylene carbonates, and the like. The HV Material may also be an emulsion that is highly viscous during flow. In many cases the HV Material is viscoelastic during flow; however, the HV Material may have other rheological flow properties as long as it is capable to move by flow and exhibits high resistant to flow, having high centipoise fluid viscosity, as later specified. Non-limiting examples are low water content, but flowable, sugar solutions, low water content, but flowable, acid solutions, polysaccharides and other natural and synthetic polymer gels, doughs, gelatins, emulsions, gelled oils, and mixtures thereof. A non-limiting example of mixtures could be low water content sugars containing polysaccharide polymers.

In one non-limiting embodiment, the relatively high viscosity material may have a viscosity ranging from about 1000 independently to about 20,000,000 centipoise (cP) at 0.01 sec⁻¹ viscosity at 80° F. (27° C.); alternatively from about 10,000 independently to about 5,000,000 cP. The relatively low viscosity fluid, as noted, has a noticeably lower viscosity relative to the relatively high viscosity material. In another non-limiting embodiment, the relatively low viscosity fluid may have a viscosity ranging from about 1 independently to about 12 cP; alternatively from about 1.2 independently to about 6 cP at 0.01 sec⁻¹ viscosity at 80° F. (27° C.). In many cases, the viscosity of the relatively low viscosity fluid is Newtonian or with an added friction reducer is substantially Newtonian (greater than 90%) in flow behavior and is similar or close to the viscosity of water, low salinity brine (i.e. 2% KCl brine), high salinity completion brine, or formation brine. As used herein, the term “independently” with respect to a range means that any lower threshold may be combined with any upper threshold to define an additional, suitable range.

The apparatus may be an on-location mixer, additive tank or injection apparatus that has precision control of extruding viscous materials, as shown in FIGS. 1 and 2. The principle use of the apparatus is for the introduction of small, but relatively highly viscous material bodies or masses into relatively lower viscosity brine during the treatment to create a very high viscosity ratio (Vᵣ) treatment fluid mostly from materials common to the shale hydraulic fracturing industry. That is, to use current materials in smarter ways to derive greater benefits or performance. The possible benefits of the high viscosity contrast fluid (HVR Fluid) include, but are not necessarily limited to: 1) allowing water that does not have its bulk viscosity increased to be the principle hydraulic fluid; 2) uniquely delaying treatment fluid “viscosity effects” (when fluid exhibits a viscosity property); 3) controlling location (targeting) of where “increased treatment fluid viscosity effects” occurs; 4) using a process for significantly reducing the amount of viscous material used compared to current treatments; and 5) more efficiently using viscous material, in quantity and function; and the like.

The characteristics of the HV Material may be optimized by controlling initial: 1) viscosity, 2) low shear rate elasticity, 3) size; 4) shape; 5) combination of sizes and/or shapes; 6) concentration to brine; 7) composition and density of brine; and 8) inclusion of treatment materials within the relatively high viscosity masses or bodies (like proppant, cleanup agent, clay control agent, breaker, tracer, and the like). Other characteristics may also be involved. The extrusion and injection apparatus may be configured for simultaneously providing several different HV Materials and inclusions during the frac treatment. More than one HV Material may vary in viscosity, composition, density, content, size, shape, concentration in the brine, and the like, for providing more versatility or wider range of fracture interaction when combined during a treatment. In one non-limiting example, when used independently, larger size and more viscous HV Material could be used to produce a HVR Fluid for improving treatment fluid diversion from the planar fracture, where a second HV Material can produce a HVR Fluid better suited for fluid diversion within narrow secondary fractures, and a third HV Material could be used to produce a HVR Fluid better suited or customized (i.e. smaller in size and contain smaller proppants) for creating tertiary and beyond fracture complexity and transitional conductivity. The HV Material apparatus can be three or more reservoir tanks with one or more extrusion devices capable of varying the size, rate and the like of HV Material extrusion from each tank. Additionally, the rate of addition (amount of HV Material added to brine over time) may vary linearly and/or in segments or may be pulses of high concentration followed by very low concentration cycles during material use. That is, the purposes of HVR Fluid use may be engineered and/or designed for particular points and times during a treatment.

There are multiple purposes for use of the materials and device, which include but are not necessarily limited to: 1) partial diversion/flow deviation in fractures (paths of least resistance to flow in hydraulic fracture); 2) total fluid diversion from fracture (use of larger size, more viscous, and more numerous masses); 3) target placement and retention of proppant within the flow restrictive “choke points” in complex fracture network; 4) delayed and targeted fluid viscosity—a type of in situ viscosity generation—that is, relatively low brine treatment fluid viscosity until specially formulated and sized viscosity material bodies encounter “confining wall shear” once they are within very narrow complex fractures (controlled by size, amount, and viscosity of material bodies); and 5) delayed release and improved distribution of treatment additives that are within the relatively high viscosity materials; and the like.

Use of these materials, fluids and apparatus should allow better treatment fluid diversion to improve the amount of surface area generated (increase the surface area ratio (Sᵣ) of complex fracture surface area (S_{cf}) to planar fracture surface area (S_{pf})). Use of these materials with proppants that are selectively sized and shaped for placement in complex fracture networks could improve transitional fracture conductivity (amount or proportion of nano-, micro-, and macro-darcy conductivity progressing from the fracture tips to wellbore perforations).

Further, the conductivity restrictive choke points (i.e. where hydrocarbon flow becomes restrictive and hinders hydrocarbon production) may be reduced by the HV Material masses or bodies containing proppant retained and placed at restrictive flow positions in complex fracture network during the treatment. The uses of the disclosed materials and addition device should be an improvement over the use of only conventional fluids and material diverters, like slickwater with slowly soluble organic acid or polymer particles (e.g. polylactic acid), and provide more options and greater control in treatment design and better success in generating complex fracture networks, transitional conductivity, and distribution of treatment additives. In one non-limiting example, it is expected that the viscosity of the HVR Fluid is more adept than viscous crosslinked polymer systems for creating complex fracture networks because: a) the fluid has brine-like viscosity from the surface to the fractures, then b) the combined character of brine and viscous masses within the fractures, with c) ability to target the deeper and more narrower fracture region before the viscous masses interact with the fracture walls (i.e. an interaction totally different than that of homogeneous crosslinked polymer interaction in fractures), with d) the fluid promotes increasing hydraulic pressure during flow only within selective width narrow fractures, that e) promotes pressure-initiated new fractures, and f) repetitively creates new fractures, and thereby the HVR Fluid is uniquely adapt for creating deeper fluid diversion and fracture complexity (i.e. due to the ability to vary during a treatment the shape, size, viscosity, composition, and concentration of HV Material bodies utilized in brine combined properties). The ability to target placement of treatment additives deeper within the complex fractures can also be engineered with the methods and compositions discussed herein, i.e. treatment additives such as scale inhibitors or cleanup agents, etc.

Stated another way, conventional viscous fluids, such as those gelled by crosslinked guar or a VES, have behavior that is independent of fracture width compared to HVR fluid. Conventional viscous fluids have the same viscosity in wide fractures, medium width fractures, narrow fractures and very narrow fractures. For HVR fluids, the effective or net viscosity increases as the walls of the fracture narrow to the extent that the size of the HV Material bodies or masses are relatively large and thus the relative size of the HV Material bodies or masses relative to the fracture width is such that the bodies or masses encounter wall shear or friction and eventually become wedged, somewhat wedged, or as they are wall-sheared and the net local viscosity of the HVR treatment fluid thus shows an effective increase in that region or location of the fracture. Indeed the tendency for the fluid to increase in net viscosity increases in select fracture regions as the HV Material bodies or masses become wedged, somewhat wedged, or as they are sheared by interaction with the walls in the narrow fractures.

In more detail, shown in FIG. 1 is a schematic illustration of the surface equipment 10 used in a treating method described herein, including a blender 12 that transports a relatively low viscosity fluid 14 via a conduit to high pressure pumps 16, which introduces the fluid as a fracturing fluid 18 into the wellbore 20 through the wellhead 22. A high Vᵣ introduction apparatus 24 may be placed between blender 12 and the high pressure pumps 16 to introduce relatively high viscosity material as masses or bodies into the relatively lower viscosity fluid 14 stream at a Vᵣ material addition point 26.

High Vᵣ introduction apparatus 24 is shown in more detail in the schematic illustration of FIG. 2 where apparatus 24 has at least one reservoir 28 that contains relatively higher viscosity material 30. As noted, relatively higher viscosity material 30 may be an aqueous gelled fluid, the viscosity of which has been increased by a polymer (e.g. a polysaccharide), a crosslinked polymer, and/or a viscoelastic surfactant (VES), and combinations thereof. Additional gelled fluid technologies may also be utilized, such as gelled hydrocarbons and viscous emulsions. At least one extrusion conduit 32 is in intermittent fluid communication between the reservoir 28 and at least one flow conduit 34 containing the lower viscosity fluid stream 14. By “intermittent fluid communication” is meant that the relatively higher viscosity material 30 is introduced only intermittently or periodically or irregularly into relatively lower viscosity fluid stream 14 since it is being cut, segmented or otherwise fragmented prior to introduction. There is at least one drive mechanism adapted to drive the higher viscosity material 30 through the at least one extrusion conduit 32 into the lower viscosity fluid stream 14, which drive mechanism may be a pressure, pump, a screw or any motive device known to the industry. The high Vᵣ introduction apparatus 24 also contains at least one sizing cutter adapted to divide the higher viscosity material 30 into discrete bodies 36 of a predetermined size. For the purposes of simpler illustration, the at least one drive mechanism and at least one cutter are illustrated as extrusion/cutter 38. The at least one cutter may have one or more blades, knives or edges that cuts the higher viscosity material 30 into the discrete bodies. The combination of the continuous lower viscosity fluid stream 14 and discrete bodies 36 of higher viscosity material comprise the fracturing fluid 18. The reservoir 28 may also be equipped with at least one metering controller (not shown) adapted to control or meter the rate at which the higher viscosity bodies are introduced into the lower viscosity fluid stream. By “metering the discrete bodies into the relatively lower viscosity fluid stream” is meant regulating and controlling how much high viscosity material is introduced into the relatively lower viscosity fluid stream.

In one sense, the fracturing fluid 18 may be understood as having two main components: a relatively low viscosity continuous media fluid 14 (e.g. brine) and relatively high viscosity discontinuous masses or bodies 36.

It will be appreciated that the viscosity ratio Vᵣ will be designed to achieve the fracturing and production purposes of the methods described herein, that is, customized to a particular situation, which makes it difficult to specify a Vᵣ that is applicable for all applications. However, in one non-limiting embodiment the viscosity ratio Vᵣ of the 0.01 sec⁻¹ viscosity at 80° F. (27° C.) of the relatively higher viscosity material to the 0.01 sec⁻¹ viscosity at 80° F. (27° C.) of the relatively lower viscosity fluid stream is 100 or greater, in one non-limiting embodiment 1000 or greater, alternatively is 10,000 or greater, and in a different non-limiting embodiment is 100,000 or greater.

Similarly, the size of the discrete bodies 36 will be designed to achieve fracturing and production purposes of the methods described herein, which may also be difficult to predict in advance. Nevertheless, to give an indication of the scale of the compositions herein, the discrete bodies 36 may have an average particle size from about 500 nm independently to about 50 cm; in one non-limiting embodiment 500 nm independently to about 30 mm, alternatively from about 1 μm independently to about 4 mm, and in another non-limiting embodiment about 10 μm independently to about 1 mm. It will be appreciated that the discrete bodies may be formed by a process that does not give bodies that are the exact same size and/or shape, but which may be with a size range and/or a shape range.

Further, representative concentrations of the discrete bodies 36 in the relatively low viscosity fluid 14 may range from about 0.1 vol % independently to about 20 vol %; alternatively range from about 0.2% vol % independently to about 5 vol %; alternatively range from about 0.25 vol % independently to about 2 vol %. The particular alternative range may vary due to the method of addition, if continuous or in slug or periodic high concentration fluid stages process of use.

The integrity of the extruded HV (high viscosity) Material to retain its size, shape, and the like during shear when being pumped downhole will depend on the viscosity, elasticity, and other properties of the HV Materials. Potentially the two most important HV Material properties will be extrusion size and amount of material viscosity for enduring high fluid shear during frac treatment placement. Another less controlling property is the density. The HV Material can be used in larger sizes with higher viscosity for providing complete fluid diversion downhole in fairly wide fracture widths; likewise the extruded HV Material can be very small in size and may only become active within very narrow fracture widths, so the HV Material activity may vary within the shale complex fracture network. A mixture of sizes and/or shapes may also be usefully employed.

It will be further appreciated that the extrusion, cutter and metering controller may be configured to be adjustable so that the rates of introduction and sizes of discrete bodies 36 may be readily changed. Furthermore, apparatus 24 may comprise more than one reservoir 28, where each reservoir 28 has a respective extrusion conduit 32, drive mechanism 38, sizing cutter 38 and metering controller. In this manner, more than one type of discrete bodies 36, more than one size of discrete bodies 36, more than one shape of discrete bodies 36, and/or more than one composition of discrete bodies 36 may be introduced into the relatively low viscosity fluid 14 to give fracturing fluid 18. Additionally, the relatively high viscosity material 30 may be different for each reservoir 28. It will be appreciated that the higher the viscosity, the longer the discrete bodies 36 will keep their shape in fracturing fluid 18. However, it will also be appreciated that populations of discrete bodies 36 of different sizes or compositions will give a broader distribution of characteristics over time and distance during placement of fracturing fluid 18.

Shown in FIGS. 3a, 3b, 3c and 3d are schematic illustrations of how the discrete bodies 36 of higher viscosity material may vary one to the other. FIG. 3a shows that the discrete bodies 36 may have different average particle sizes. FIG. 3b schematically illustrates that the discrete bodies 36 may have different viscosities, where the heavier the shading, the greater the viscosity. FIG. 3c schematically illustrates how the discrete bodies 36 may be of different shapes, for instance a spherical shape at the top; to bent round rods or pins shapes, second; to straighter round rods or pins shapes, third; and long-aspect rectangles (for instance, a “French fry”-like shape), or discs of varying thickness (for instance, flattened spheres or egg-shapes) shapes, fourth. It may be found that some shapes may work better than others at holding their shape in different applications, or may function better than others for certain purposes, e.g. distributing proppants or enclosed additives. FIG. 3d schematically illustrates how different shapes may contain various other materials. Of course, it will be appreciated that these various characteristics may be combined with each other so that the discrete bodies 36 may be customized for a particular application.

Following up on the discrete bodies 36 embodiment in FIG. 3d, FIG. 4a illustrates a spherical encapsulant 40 containing a treatment agent in the high viscosity body 42. Internal additives 40, 44 and 48 typically will be blended into high viscosity material 30 in reservoir 28 prior to extrusion through conduit 32 into discrete bodies 42, 46 and 50. The apparatus 24 may further comprise at least one internal injector (not shown) adapted to inject an internal additive 40, 44 and 48 into the discrete bodies 42, 46 and 50, respectively. Alternatively, the internal additives 40, 44 and 48 may be pre-mixed within the HV Material. The encapsulated internal additive in encapsulant 40 may include, but not necessarily be limited to, biocides, tracers, proppants, self-assembling nanocoating agents for modifying fracture face properties, surfactants, scale inhibitors, asphaltene inhibitors, hydrogen sulfide scavengers, polymer breakers, VES breakers, microemulsions to improve treatment fluid cleanup, other treatment fluid cleanup agents, fines migration control additives, fines migration control nanoparticles, fracture imaging materials (diagnostic agents that interact with signals and sensors), and combinations thereof. For instance, one type of nanocoating agent may be surface-modifying agents to introduce hydrophobicity and/or oleophobicity to the fracture surfaces. Body 46 may contain a dispersed or soluble agent 44 as shown in FIG. 4b. The encapsulated internal additive in body 46 may include, but not necessarily be limited to, biocides, tracers, self-assembling nanocoating agents for modifying fracture face properties, surfactants, scale inhibitors, asphaltene inhibitors, hydrogen sulfide scavengers, polymer breakers, VES breakers, microemulsions to improve treatment fluid cleanup, other treatment fluid cleanup agents, fines migration control additives, fines migration control nanoparticles, fracture imaging materials (diagnostic agents that interact with signals and sensors), and combinations thereof. Body 50 may contain dispersed proppant particles 48 as shown in FIG. 4c. Suitably the proppants 48 will be unconventional in size and lightweight, having a specific gravity from 0.9 to 1.8, in another non-limiting embodiment 1.0 to 1.2. The smaller size will depend on the complex fracture widths for the particular lithology that is hydraulically fracture treated. In most cases the unconventional proppants will be less than 1 mm but larger than 10 microns. Conventional proppants 48 well known in the art in size and density may also be used in body 50, but most typically will be for the wider complex fractures and planar fracture to provide millidarcy to macrodarcy fracture conductivities. Composition of suitable proppants or propping agents 48 include, but are not limited to, for instance, quartz sand grains, glass beads, ceramic beads, bauxite beads or grains, walnut shell fragments, aluminum pellets, nylon pellets, resin pellets, other plastic pellets, composite pellets of various agents such as walnut shells and resin, nanomaterial coated proppants, and the like. Other additives may include, but are not necessarily limited to, piezoelectric particles, metal particles, metal complexes, metal salts, fines control agents, solid acids, solid high pH buffers, salts, chelants, oxidizers, plant and fish oils, mineral oils, shape memory polymers, fibers, glass spheres, encapsulations and combinations thereof.

Shown in FIG. 5a is a schematic illustration of the discrete bodies 36 entering a fracture 52 under the influence of the fracturing fluid 18. As the width of the fracture 52 narrows the discrete bodies 36 interact with the fracture walls. The masses of the discrete bodies 36 in FIG. 5a and FIG. 5b are examples of specific type of discrete bodies 36 that will more easily deform in the narrow fracture region of fracture 52. The deformation of bodies 36 are by interaction with the walls of fracture 52, where the shear force relatively thins the viscosity of bodies 36. The more they shear thin and deform, the more fluid-like, that is, more willing to flow or less viscous, they become. Depending on their initial viscosity and fracture wall-induced shear thinning properties, discrete viscous bodies 32 become discrete viscous fluid bodies 54 that occupy greater fracture surface area within the narrow region of fracture 52, as represented by viscous deformed masses 54 shown in FIG. 5b. Viscous deformed masses 54 represent the adaptive properties of relatively high viscosity bodies 36, where they can be transformed or modified in situ into discrete viscous fracturing fluid masses. The ability to transform bodies 36 into viscous fluid masses 54 will promote unique hydraulic pressure with the brine within the fracture 52, generating a combined brineviscous fluid hydraulic pressure medium to slow and eventually prevent further fracture growth and the restrictive flow pressure will initiate a new fracture and create fluid diversion. This process can be continuous during the frac treatment and create diversion and fracture complexity quite differently than if only one fluid was present, such as slickwater or viscous crosslinked polymer fluid, or even if the slickwater and crosslinked polymer fluids were staged. Staged fluids of slickwater and crosslinked polymer would not have similar properties compared to slickwater brine with transformable discrete bodies 36 creating viscous fluid masses 54 in select regions of the reservoir. Additionally, viscous fluid masses 54 can possibly occupy greater fracture surface area the deeper masses 54 penetrate. When the masses of the discrete bodies 36 contain proppant and create greater fracture surface area masses 54, they will thus create channel-type conductivity, as illustrated in FIG. 5b.

However, as schematically illustrated in FIG. 5b, the viscous gel bodies 36 generate viscosity only in very narrow fractures. Narrow fractures are defined as less than 1 mm wide, and may range from about 1 μm (micrometer) up to 1 mm. The typical range where viscous gel bodies 36 generate viscosity and form high fracture surface area fluid masses 54 will be from about 0.5 mm to about 0.02 mm, in one non-limiting example. For relatively wider fracture widths, the discrete bodies 36 will retain their shapes as shown in the left side of FIG. 5b. However, for very narrow fracture widths, as at the bottom of fracture 52 in FIG. 5a, and the right side of FIG. 5b, the discrete bodies 36 will form wall-shear deformed discrete fluid masses 54 and generate viscosity in the fracturing fluid 18 as well as provide the diverting function. That is, where the bodies 36 are wedged in the tip of fracture 52, they will shear thin and optimize to the local fluid pressure conditions for limiting fracture 52 growth and in one non-limiting embodiment induce a new fracture off of fracture 52.

FIG. 6 is a schematic illustration of possible choke points in a complex fracture network production system having a wellbore 60 from which extends a primary, propped fracture 62, and a plurality of more complex, secondary, unpropped fractures 64. The extent of stimulated rock volume (SRV) is represented by dashed line boundary 66. The value X_{pf} is the half-length of the primary fracture 62, which is a bilength of the total fracture since it should be keep in mind that generally there is a biwing (half of which is not shown) extending from wellbore 60 on the opposite side (downward in the FIG. 6 orientation). The term dᵣ is the distance between unpropped secondary fractures 64. L_{sf} is the length of the secondary fractures. It will be appreciated that fractures created during hydraulic fracturing will not form the regular “grid” of fractures 62 and 64 schematically illustrated in FIG. 6, but will instead be more irregular.

The shaded areas are representative of the potential choke points, where 68 is the near wellbore potential choke point (i.e. near wellbore location in hydraulically fractured production system that has insufficient fracture conductivity and thus restricts the rate of flow of hydrocarbons) where primary fracture 62 extends from the wellbore, potential choke point 70 (i.e. another rate restrictive fracture conductivity location) is along primary fracture 62, potential choke point 72 is along secondary fracture 64 and potential choke point 74 is within the unfractured shale of the SRV. The incidence and/or extent of these conductivity choke points 68, 70, and 72 and may be reduced by the viscous masses or bodies 36 which contain proppant 48, which are retained at these restrictive flow locations in the complex fracture network during a fracture treatment. The ability to pinpoint placement of proppant by selectively sized viscous masses that become wedged at these locations will prevent or greatly reduce the lack of propped fracture conductivity at these locations.

It will be further appreciated that the compositions and methods for placement of unconventional and conventional proppants here will help create a transition of propped fracture conductivity from the fracture tip to the wellbore, starting with nanodarcy permeabilities at the fracture tips, to microdarcy permeabilities in the complex, secondary fractures to millidarcy to darcy permeabilities near the primary fracture, then to darcy to macrodarcy permeabilities within the primary propped fracture.

In another non-limiting embodiment each HV Material discrete body may be provided with the right type and amount of internal viscosity breaker so that it will break (have its viscosity reduced) under downhole conditions in the correct locations.

Thus, the methods, compositions and apparatus described herein involve the development of a “smart” fluid particularly adapted to hydraulically fracture shale, coal and tight formations. By use of a high viscosity internal phase material in the water phase, the fracturing fluid has initial properties of slick water and has higher viscosity properties once it is in select sections of the narrow width complex fractures network. The High Viscosity (HV) Material may be formed from a wide range of gel technology (e.g. crosslinked polymers, VES, highly viscous emulsions and microemulsions, gelled oils, gelatins, and the like). The shape, size, viscosity, concentration, content, density, salinity, and the like may be adjusted to result in a fluid with a wide range of properties for varying widths and lengths of fractures.

More than one HV Material may be utilized for treating different fracture characteristics during the treatment. FIG. 1 illustrates how a device can extrude and deliver the HV Material to brine on location. This fluid technology may be used for: a) at low concentration in brine, inducing paths of least resistance flow deviation; b) improving complex fracture network proppant placement, particularly unconventional proppants; c) highly versatile fluid diversion; d) in situ viscosity generation; and e) distributing delayed release treatment additives. This technology is an alternative to conventional material diverters and may provide more versatile treatment designs and results. Each HV extruded Material-particle may contain viscosity breaker or be self-breaking under downhole conditions.

Additionally, alternative extrusion methods to create HVR Fluid may use different equipment and processes than those described above. For example, HVR masses could be generated by sending highly viscous fluid through a centrifugal pump (or a more optimum shear and transfer device) followed by proportional injection or placement into the low viscosity treatment fluid (i.e. brine or slickwater) as a means to manufacture HVR Fluid. Another non-limiting example is one where HVR masses are generated by sending highly viscous fluid through a single fixed perforated plate with selectively sized and shaped holes and optionally passing the discrete bodies through a second in-line perforated plate with select holes geometry, followed by proportional addition into the low viscosity treatment fluid. Proportional addition may occur just before placing the high viscosity ratio fluid composition in a residence tank, or shortly before or during the hydraulic fracturing treatment. These alternative methods may provide a balance between ease of manufacturing during the treatment and expense of equipment required, versus precision of the HVR masses that are incorporated into the low viscosity fluid to manufacture HVR Fluid. In other words, the use of alternative processes and equipment of manufacturing HVR Fluid that is easier, less expensive, and/or quicker to deliver to the hydraulic fracturing market or utilize in remote geographic locations.

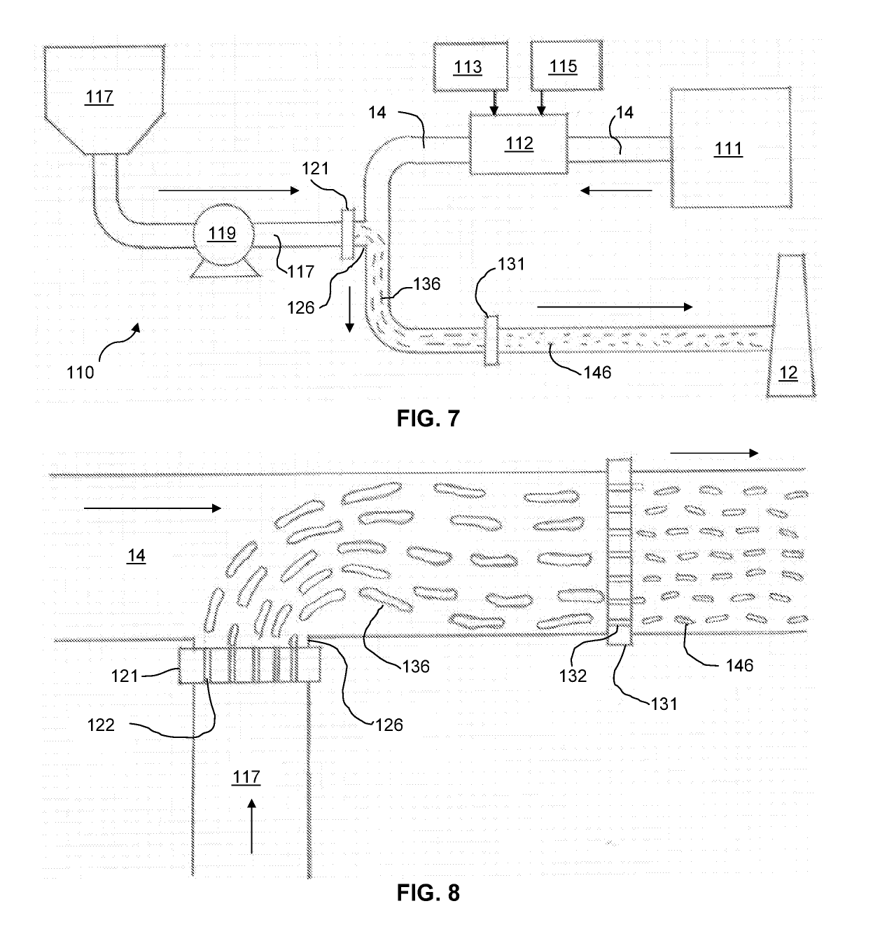

In more detail, shown in FIG. 7 is surface equipment 110 used in a treating method described herein, including a low viscosity fluid 14 (i.e. water or brine) tank 111, which is transported into blender 112. Proppant 113 and one or more treatment additive 115 may be added to low viscosity fluid 14 in blender 112. A high Vᵣ material storage tank 224 may have high Vᵣ material 117 pumped via any suitable type of pump 119 through first perforated plate 121 that shapes the HV Material prior to adding to the relatively low viscosity water or brine at addition point 126. Pump 119 may be any suitable pump including, but not necessarily limited to a centrifugal pump, a positive displacement pump (which may cause less shearing than a centrifugal pump), and the like. The extrusion of the HV Material through first perforated plate produces discrete bodies 136 of a first size and shape born along in fluid 14. The discrete bodies 136 may subsequently encounter downstream an optional second perforated plate 131 that optionally changes the size and/or shape of the discrete bodies 136 to discrete bodies 146 of a different size and/or shape prior to delivery to the wellhead 22.

Shown in FIG. 8 is detailed view of the injection point 126 and first perforation plate 121 and optional second perforation plate 131. As noted with respect to FIG. 7, relatively low viscosity fluid 14 is shown flowing in a conduit. High Vᵣ material 117 under force of pump 119 is extruded through the perforations 122 of first perforation plate 121 and the high Vᵣ material 117 is extruded into relatively low viscosity fluid 14. The shearing force of fluid 14 breaks up the strands of high Vᵣ material 117 into discrete bodies 136 that fall within an engineered size range. Under the influence of fluid 14, discrete bodies 136 encounter optional second perforation plate 131 with perforations 132 that reduce the size of discrete bodies 136 into discrete bodies 146, and perhaps also change their shape. It will be understood that FIGS. 7 and 8 are not to scale and it is unlikely that first perforation plate 121 and optional second perforation plate 131 would be placed as close together as shown in FIG. 8. For instance, it is likely that there would need to be sufficient distance between plates 121 and 131 for the discrete bodies 136 to distribute within and through fluid 14. It will also be understood that the flow rates, high Vᵣ material addition rates, sizes of perforations 122 and 132 and other factors will need to be designed so that discrete bodies 136 will be further shaped by perforations 132 and not pile up against and clog optional second perforation plate 131. It will be further appreciated that there may be other optional perforation plates placed downstream for subsequent shaping of the discrete bodies, as desired.

In the foregoing specification, the invention has been described with reference to specific embodiments thereof, and has been demonstrated as effective in providing methods and apparatus for hydraulic fracturing in subterranean formations, particularly shale formations. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of extrusion apparatus, cutting apparatus, shaping apparatus, relatively low viscosity fluids, relatively high viscosity materials, high viscosity ratio fluids, proppants, and other additives are expected to be within the scope of this invention. Further, it is expected that the components and proportions of the various components may change somewhat from one application to another and still accomplish the stated purposes and goals of the compositions and methods described herein. For example, the compositions and methods may use different components, additives and additive/component combinations, different component proportions and additional or different steps than those described and exemplified herein.

The words “comprising” and “comprises” as used throughout the claims is to be interpreted as “including but not limited to”.

The present invention may suitably comprise, consist or consist essentially of the elements disclosed and may be practiced in the absence of an element not disclosed. For instance, in an apparatus for introducing higher viscosity material into a lower viscosity fluid stream, the apparatus may consist or consist essentially of at least one reservoir adapted to contain a relatively higher viscosity material, at least one extrusion conduit in fluid communication between the at least one reservoir and at least one flow conduit containing the relatively lower viscosity fluid stream, at least one drive mechanism adapted to drive the relatively higher viscosity material through the at least one extrusion conduit into the relatively lower viscosity fluid stream, at least one sizing mechanism adapted to divide the relatively higher viscosity material into discrete bodies in a predetermined size range, where the sizing mechanism is at least one cutter and/or at least one perforation plate.

Additionally, in a method for introducing a relatively higher viscosity material into a relatively lower viscosity fluid stream, the method may consist essentially of or consist of flowing a relatively lower viscosity fluid stream, driving a relatively higher viscosity material from a reservoir through an extrusion conduit and sizing mechanism to divide the relatively higher viscosity material into discrete bodies of a predetermined size, and metering the discrete bodies into the relatively lower viscosity fluid stream.

Also, in a method of generating diversion during the fracturing of a subterranean formation through which a wellbore has been drilled, the method may consist of or consist essentially of introducing through the wellbore, at a sufficient rate and pressure to fracture the subterranean formation, a brine fracturing fluid consisting of or consisting essentially of a relatively lower viscosity fluid stream and a plurality of discrete bodies of a relatively higher viscosity material, where the method further consists of or consists essentially of diverting the relatively lower viscosity fluid stream by action of the discrete bodies of a relatively higher viscosity material.

There is further provided a relatively high viscosity ratio fluid composition consisting of or consisting essentially of a relatively lower viscosity fluid and a plurality of relatively higher viscosity material discrete bodies, where the viscosity ratio Vᵣ of the viscosity of the relatively higher viscosity material to the viscosity of the relatively lower viscosity fluid stream is 1000 or greater.

What is claimed is:

1. A method for introducing a relatively higher viscosity material into a relatively lower viscosity fluid stream, the method comprising:
flowing a relatively lower viscosity fluid stream;
driving a relatively higher viscosity material from a reservoir through at least one extrusion conduit and at least one sizing mechanism to divide the relatively higher viscosity material into discrete bodies of a predetermined size; and
metering the discrete bodies into the relatively lower viscosity fluid stream.

2. The method of claim 1 where the viscosity ratio Vᵣ of the viscosity of the higher viscosity material to the viscosity of the relatively lower viscosity fluid stream is 100 or greater.

3. The method of claim 1 where the discrete bodies of relatively higher viscosity material further comprise an internal additive selected from the group consisting of biocides, tracers, proppants, nanocoating agents, surfactants, scale inhibitors, asphaltene inhibitors, hydrogen sulfide scavengers, nanoparticles, polymer breakers, VES breakers, microemulsions, fines migration control additives, fracture imaging materials, piezoelectric particles, metal particles, metal complexes, metal salts, fines control agents, solid acids, solid high pH buffers, salts, chelants, oxidizers, plant and fish oils, mineral oils, shape memory polymers, fibers, glass spheres, encapsulations, and combinations thereof.

4. The method of claim 1 where the relatively lower viscosity fluid stream is selected from the group consisting of a brine fracturing fluid, slickwater, and combinations thereof.

5. The method of claim 4 where the brine fracturing fluid comprises proppant.

6. The method of claim 1 where the relatively higher viscosity material is selected from the group consisting of non-crosslinked polymers; crosslinked polymers; viscoelastic surfactant gels; vesicles; viscous emulsions; aqueous gels having a water content less than about 40 wt % further selected from the group consisting of sugar solutions, acid solutions, polysaccharides, doughs, gelatins; hydrocarbon gels having a liquid hydrocarbon content less than about 60 wt % further selected from the group consisting of alcohols, mineral oils, glycerin, glycols, glycol ethers, d-limonene, terpenes, propylene carbonate, ethylene carbonate; and combinations thereof.

7. An apparatus for introducing a relatively higher viscosity material into a lower viscosity fluid stream, the apparatus comprising:
at least one reservoir adapted to contain higher viscosity material;
at least one extrusion conduit in fluid communication between the at least one reservoir and at least one flow conduit containing the relatively lower viscosity fluid stream;
at least one drive mechanism adapted to drive the relatively higher viscosity material through the at least one extrusion conduit into the relatively lower viscosity fluid stream; and
at least one sizing mechanism adapted to divide the relatively higher viscosity material into discrete bodies within a predetermined size range, where the sizing mechanism is selected from the group consisting of at least one cutter, at least one perforation plate, and combinations thereof.

8. The apparatus of claim 7 comprising more than one reservoir, where each reservoir has at least one respective extrusion conduit, drive mechanism, sizing cutter and metering controller.

9. The apparatus of claim 7 where the at least one sizing mechanism is a cutter is adapted to be able to change the size of the discrete bodies.

10. The apparatus of claim 7 further comprising at least one internal injector adapted to inject an internal additive into the discrete bodies.

11. The apparatus of claim 7 where:
the lower viscosity fluid stream is selected from the group consisting of brine, slickwater and combinations thereof, and
the higher viscosity material is selected from the group consisting of non-crosslinked polymers; crosslinked polymers; viscoelastic surfactant gels; vesicles; viscous emulsions; aqueous gels having a water content less than about 40 wt % further selected from the group consisting of sugar solutions, acid solutions, polysaccharides, doughs, gelatins; hydrocarbon gels having a liquid hydrocarbon content less than about 60 wt % further selected from the group consisting of alcohols, mineral oils, glycerin, glycols, glycol ethers, d-limonene, terpenes, propylene carbonate, ethylene carbonate;
and combinations thereof.

12. The apparatus of claim 1 further comprising at least one metering controller adapted to control the rate at which the relatively higher viscosity bodies are introduced into the relatively lower viscosity fluid stream,

13. A method of generating diversion during the fracturing of a subterranean formation through which a wellbore has been drilled, the method comprising:
introducing through the wellbore, at a sufficient rate and pressure to fracture the subterranean formation, a fracturing fluid comprising:
a relatively lower viscosity fluid stream; and
a plurality of discrete bodies of a relatively higher viscosity material; and
the discrete bodies of the relatively higher viscosity material diverting the relatively lower viscosity fluid stream.

14. The method of claim 13 where the fracturing fluid comprises a proppant.

15. The method of claim 13 where the discrete bodies comprise a proppant.

16. The method of claim 13 where the viscosity ratio Vᵣ of the viscosity of the relatively higher viscosity material to the viscosity of the relatively lower viscosity fluid stream is 100 or greater.

17. The method of claim 13 where the discrete bodies of relatively higher viscosity material further comprise an internal additive selected from the group consisting of biocides, tracers, proppants, nanocoating agents, surfactants, scale inhibitors, asphaltene inhibitors, hydrogen sulfide scavengers, nanoparticles, polymer breakers, VES breakers, microemulsions, fines migration control additives, fracture imaging materials, piezoelectric particles, metal particles, metal complexes, metal salts, fines control agents, solid acids, solid high pH buffers, salts, chelants, oxidizers, plant and fish oils, mineral oils, shape memory polymers, fibers, glass spheres, encapsulations, and combinations thereof, and the method further comprises releasing the internal additives into the lower viscosity fluid stream.

18. The method of claim 13 where the discrete bodies generate viscosity in the lower viscosity fluid stream in narrow fractures and under high fracture wall shear.

19. The method of claim 13 where the higher viscosity material is selected from the group consisting of non-crosslinked polymers; crosslinked polymers; viscoelastic surfactant gels; vesicles; viscous emulsions; aqueous gels having a water content less than about 40 wt % further selected from the group consisting of sugar solutions, acid solutions, polysaccharides, doughs, gelatins; hydrocarbon gels having a liquid hydrocarbon content less than about 60 wt % further selected from the group consisting of alcohols, mineral oils, glycerin, glycols, glycol ethers, d-limonene, terpenes, propylene carbonate, ethylene carbonate.

20. A high viscosity ratio fluid composition comprising:
a relatively lower viscosity fluid; and
a plurality of relatively higher viscosity material discrete bodies;
where the viscosity ratio Vᵣ of the viscosity of the higher viscosity material to the viscosity of the lower viscosity fluid stream is 100 or greater.

21. The high viscosity ratio fluid composition of claim 20 where the relatively lower viscosity fluid stream is selected from the group consisting of brine, slickwater and combinations thereof, and where the relatively higher viscosity material is water gelled with a gelling agent selected from the group consisting of non-crosslinked polymer, crosslinked polymer, viscoelastic surfactant, and combinations thereof.

22. The high viscosity ratio fluid composition of claim 20 where the discrete bodies have an average particle size from about 500 nm to about 50 cm.

23. The high viscosity ratio fluid composition of claim 20 further comprising proppant.

24. The high viscosity ratio fluid composition of claim 23 where the discrete bodies further comprise the proppant.

25. The high viscosity ratio fluid composition of claim 20 where the discrete bodies of relatively higher viscosity material further comprise an internal additive selected from the group consisting of biocides, tracers, proppants, nanocoating agents, surfactants, scale inhibitors, asphaltene inhibitors, hydrogen sulfide scavengers, nanoparticles, polymer breakers, VES breakers, microemulsions, fines migration control additives, fracture imaging materials, piezoelectric particles, metal particles, metal complexes, metal salts, fines control agents, solid acids, solid high pH buffers, salts, chelants, oxidizers, plant and fish oils, mineral oils, shape memory polymers, fibers, glass spheres, encapsulations and combinations thereof.
